(19) United States
(12) Patent Application Publication
(10) Pub. No.: US 2008/0031595 A1
(43) Pub. Date: Feb. 7, 2008

(54) Method of controlling receiver and receiver using the same

(75) Inventor: Eun Hyung Cho, Gumi-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/702,572

(22) Filed: Feb. 6, 2007

(30) Foreign Application Priority Data
Aug. 7, 2006 (KR) 10-2006-0074213

(51) Int. Cl. H04N 5/91

(52) U.S. Cl. 386/108

(57) ABSTRACT

A receiver and receiver control method facilitate user access to recorded content, including access for viewing, editing, and deletion, by providing means for improved file recognition so that recording items can be accurately and efficiently confirmed via a main screen without playing back any of the recording items in full. The method uses a recording list including at least one window, at least one progress bar, and additional information such as a program title and enables the recording list to be constructed from a received stream. The method includes steps of receiving at least one video program; and constructing a recording list from the received at least one video program, the recording list including at least one window, at least one progress bar, and additional information indicative of at least one feature identifying a corresponding video program of the recording list, each window corresponding to one video program of the recording list and each progress bar corresponding to one video program of the recording list, wherein at least part of a specified video program is displayed in a corresponding window of the constructed recording list in response to a user command for controlling a corresponding progress bar of the constructed recording list. A specific recording item (video program) may be selected in correspondence to a thumbnail image displayed as part of the recording list. The selected video program or a video sample thereof is displayed, after scaling, to occupy a screen area coinciding with a screen area previously occupied by the corresponding thumbnail image.

This application claims the benefit of Korean Patent Application No. 10-2006-0074213, filed on Aug. 7, 2006, which is hereby incorporated by reference as if fully set forth herein.

### BACKGROUND OF THE INVENTION

1. Field of the Invention

The present invention relates to a method of controlling a receiver and to a receiver using the same, in which a displayed recording list facilitates user access to recorded content.

2. Discussion of the Related Art

A video apparatus (e.g., a video receiver) may be provided with a digital video recorder including a digital video storage device such as a digital versatile disc or DVD. Meanwhile, as a next-generation recording device, a personal video recorder makes use of a hard disk providing large-capacity video storage, whereby a hard disc drive may be installed as part of a set-top box system or may be incorporated into a digital television receiver, to record information (content) on the hard disk using a conventional computer file format enabling access to the stored content to, for example, play back the recorded information. Thus, in addition to a large-capacity hard disk, the personal video recorder is provided with a central processing unit for executing reproduction operations and a memory chip loaded with an operating system and reproduction software.

Accordingly, in a video apparatus as above, one of a plurality of stored programs or streams of audio and video data are recorded and stored in a storage medium as recording items (files) comprising a recording list. To selectively reproduce (play back) any one of the stored recording items, the recording list is displayed on a main screen of the video apparatus, using an externally connected device such as a television receiver, enabling a selected recording item to be reproduced for viewing, editing, etc. That is, a user typically makes a selection from the displayed list and, using a user interface such as a remote controller or local keypad, commands the central processing unit of the personal video recorder to execute a reproduction operation for the selected recording item. A display of a recording list includes at least one identifier corresponding to each of a predetermined set of recording items, such as a program title, which may be displayed together with corresponding recording time information, and is typically arranged within a menu displayed via an on-screen display function. To facilitate user recognition of a specific recording item, the menu may also include a thumbnail (frame image) displayed adjacent the program titles and other textual information. Further, the recording list may be used to create a playlist, which is specified by a user designating a plurality of recording items to be reproduced in a designated sequence.

There may be occasions, however, where the displayed information of the menu—including an associative display of thumbnals—is insufficient for enabling the user to recognize or correctly identify one or more of the recording items to be played back or otherwise accessed, such that several attempts may be necessary to select a specific recording item as desired. The user may even need to confirm the exact contents of multiple recording items by repetitively initiating a full playback operation for each item. For example, if the user is less than thoroughly familiar with the contents of a recording item, a corresponding thumbnail image may be insufficient for the user to identify the exact content. This situation is especially problematic when preparing a playlist and when there are a number of an unsuccessful confirmations of the contents of a selected item, whereby one or both of the original recording list and a playlist being specified must be redisplayed on the screen after each unsuccessful confirmation.

### SUMMARY OF THE INVENTION

Accordingly, the present invention is directed to a receiver and receiver control method that substantially obviate one or more problems due to limitations and disadvantages of the related art.

An object of the present invention is to provide a receiver and receiver control method, which enables the construction of a recording list from a received stream.

Another object of the present invention is to provide a receiver and receiver control method, by which information on recording items can be accurately and efficiently confirmed via a main screen without playing back recording items one by one.

Another object of the present invention is to provide a receiver and receiver control method, which facilitates user access to recorded content, including access for viewing, editing, and deletion, by providing means for improved file recognition and thereby increasing accuracy of the user's identification of recording files.

Another object of the present invention is to provide a receiver and receiver control method, which enables a user to be provided with additional information for confirming the contents of a recording item being accessed.

Another object of the present invention is to provide a receiver and receiver control method, which enables a user unfamiliar with the contents of one or more recording items of a recording list to select a specific recording item to be reproduced and to create a playlist of a plurality of specific recording items, using a menu displayed on a main screen of a video apparatus without initiating a full playback operation for any of the recording items.

Another object of the present invention is to provide a receiver and receiver control method, which provides an enhanced search function for a specific recording item of a recording list displayed on a main screen of a video apparatus.

Another object of the present invention is to provide a receiver and receiver control method, which imparts a video apparatus with a simplified preview mode for recording video files.

Another object of the present invention is to provide a receiver and receiver control method, which facilitates a comparison of video file lengths (sizes) by enabling a user to ascertain relative file length visually.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention, as embodied and broadly described herein, there is provided a method of controlling a receiver. The method comprises receiving at least one video program; and constructing a recording list from the received at least one video program, the recording list including at least one window, at least one progress bar, and additional information indicative of at least one feature identifying a corresponding video program of the recording list, each window corresponding to one video program of the recording list and each progress bar corresponding to one video program of the recording list, wherein at least part of a specified video program is displayed in a corresponding window of the constructed recording list in response to a user command for controlling a corresponding progress bar of the constructed recording list. In doing so, the constructed recording list may be stored in a storage device.

According to another aspect of the present invention, there is further provided a receiver control method comprising storing in a video storage device at least one stream of audio and video data corresponding to a plurality of frames, each stream including additional information indicative of at least one feature of a set of recording item details for identifying a recording item; extracting recording item information included in each stream, the recording item information including the at least one recording item feature for each item of a recording list; displaying, in response to a user command requesting display of the recording list, the stored at least one recording item feature and at least one window in association with the at least one recording item feature; and displaying, in response to a user command selecting a specific recording item, at least part of the stream stored in correspondence to the selected recording item. Preferably, the specific recording item is selected by a user clicking on a screen area corresponding to a thumbnail image displayed as part of the recording list, so that the displayed video sample may occupy a screen area coinciding with a screen area previously occupied by the corresponding thumbnail image, thereby providing a simplified preview mode for recording video files to be confirmed prior to entering a full reproduction operation.

According to another aspect of the present invention, there is provided a receiver comprising a video storage device for storing at least one video program including additional information indicative of at least one feature of each stored video program; a recording item information extractor for extracting recording item information from each stream, the recording item information including the at least one video program feature for each item of a recording list; and a system controller for outputting the recording list in response to a user command requesting display of the recording list, the output recording list including at least one window in association with the stored at least one video program feature, and for controlling, in response to a user command selecting a specific recording item, a corresponding window to display at least part of the video program according to the selected recording item.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a video apparatus according to the present invention;

FIGS. 2A-2C are exemplary diagrams of an on-screen image including a recording list displayed by a video apparatus according to first, second, and third embodiments of the present invention, respectively; and

FIG. 3 is a flowchart of a method of controlling a video apparatus according to the present invention.

### DETAILED DESCRIPTION OF THE INVENTION

Reference will now be made in detail to exemplary embodiments of the present invention, examples of which are illustrated in the accompanying drawings. Wherever possible, like reference designations will be used throughout the drawings to refer to the same or similar parts.

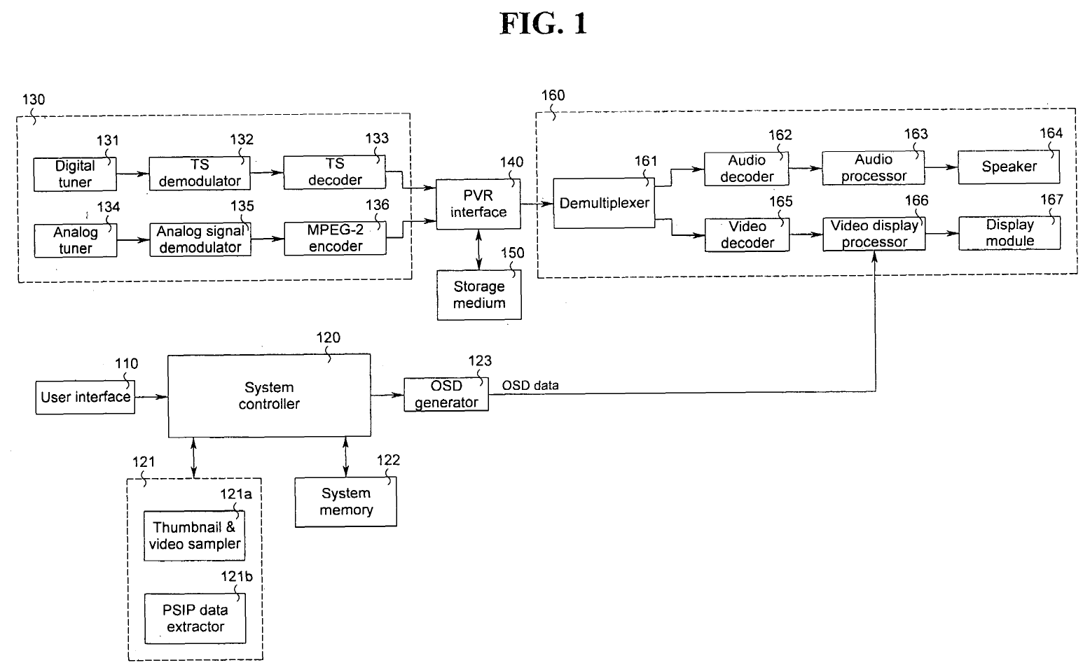

Referring to FIG. 1, a video apparatus according to the present invention includes a user interface 110, a system controller 120, a recording item information extractor 121 including a thumbnail and video sampler 121a and a program and system information data (PSIP) data extractor 121b, a system memory 122, an on-screen display (OSD) generator 123, a signal receiving section 130, a personal video recorder (PVR) interface 140, a storage medium 150, and an output section 160. According to a system program stored in the system memory 122 and user commands received from a user manipulating the user interface 110, the system controller 120 controls overall system operation and, though not specifically shown in the drawing, controls the operation of and interfaces with each element of the video apparatus. The user interface 110 may be embodied by a remote controller for controlling the video apparatus or a local keypad provided to a main body of the video apparatus. The storage medium 150, such as that used in a personal video recorder, may be embodied by a large-capacity recording medium such as a hard disk drive or by various other memory devices for storing audio and video data, including smart cards and optical discs (DVDs).

In addition to storing audio and video data, the storage medium 150 stores a set of recording item details in correspondence with each recording item. The recording item details may be displayed as text information and may include an indication of one or more features of a recording source (input port, channel, medium, etc.), a program title (including episode number), a program genre, a viewer rating, a recording date, and time information per frame (in hours, minutes, and seconds as, e.g., 00:00:00), which may be used to generate a recording start time, a recording end time, a total recording time, and a playback progress time based on a currently displayed frame. The time information may also be used to generate a progress bar for indicating a current playback status of a corresponding recording item, and the text information may be displayed together with a corresponding progress bar and other graphics-based images, e.g., a menu format, using an OSD function performed by the OSD generator 123 under control of the system controller 120. The storage medium 150 also stores a thumbnail image and video sample corresponding to each stored recording item. The thumbnail image is a still image and may correspond to a first frame or random frame of the corresponding video sample or may correspond to a first frame or random frame of an entire video file, i.e., the corresponding recording item itself. Each video sample is a series of frames of a predetermined period. Here, the predetermined period may be variably set by the user and should be sufficiently long to impart the user with a sense of the stored content. That is, the predetermined period may be less than the length of the selected recording item. The predetermined period may, however, be equal to the length of the recording item itself, such that the full video program is displayed according to the user selection from the recording list, whereby its display may then be selectively controlled (e.g., to perform time-shifting or trick-playing) according to a manipulation (user control) of the progress bar using its indicator.

According to the present invention, the recording item information extractor 121 extracts recording item information to be stored in the storage medium 150. Recording item information is set for each recording item and comprises the aforementioned thumbnail image, video sample, and at least one feature of the recording item details. The thumbnail and video sampler 121a selects, under control of the system controller 120, specific frames representative of the stored video content, whereby one selected frame is extracted to serve as a thumbnail image and a plurality of consecutive frames is extracted to serve as a video sample. Meanwhile, the PSIP data extractor 121b extracts the at least one feature of the recording item details under control of the system controller 120. Then, also under control of the system controller 120, the extracted images and recording item details are stored in the storage medium 150. PSIP data and selected frames of the received video stream may be extracted, before storage, by controlling the TS decoder 133. An index assigned by the system controller 120 to each unit of recording item information, namely, the details of one recording item, its representative thumbnail image, and its representative video sample, may be stored in the system memory 122 to enable the system controller to identify each recording item and its associated display information. By referencing the index, the system controller 120 reads the stored recording item information according to a recording item request made by a user and, in accordance with one of the embodiments of the present invention, displays the information on a main screen of the video apparatus.

The signal receiving section 130, which includes a digital tuner 131 for receiving digital television signals, a transport stream (TS) demodulator 132, a TS decoder 133, an analog tuner 134, an analog signal decoder 135 for receiving analog television signals, and an MPEG-2 encoder 136, selects an input signal by, for example, tuning a specific channel to receive a transport stream type digital broadcast signal, which includes audio data, video data, and additional data, such as PSIP data. In doing so, the digital tuner 131 or analog tuner 134 receives a corresponding broadcast signal, i.e., digital or analog, on a respectively selected channel. Thereafter, the TS demodulator 132 or analog signal demodulator 135 demodulates the correspondingly received signal. The TS decoder 133 decodes the received digital signal and outputs transport stream including audio and video data to the PVR interface 140. Likewise, the MPEG-2 encoder 136 encodes an analog broadcast signal, so that the PVR interface 140 may be provided with a digital signal enabling file allocation, search operations, individual frame selection, etc. to be performed on data stored in the storage medium 150. The signal receiving section 130 may further include an external signal input port (not shown) connected to an auxiliary input device, such as a DVD player or digital camera, acting as a source of audio and video data. In the event of an analog input signal or other video signal that may be input without PSIP data, recording item details may be specified by a user after storage.

The output section 160, which includes a demultiplexer 161, an audio decoder 162, an audio processor 163, a speaker 164, a video decoder 165, a video display processor 166, and a display module 167, outputs audio and video signals reproduced from the storage medium 150 or an output from the signal receiving section 130 transmitted via the PVR interface 140. The output section 160 also displays all the recording item information, including the recording item details, thumbnail, and video sample, corresponding to each item of a recording list displayed according to a user command. Accordingly, the demultiplexer 161 outputs an audio data stream and a video data stream, so that the audio and video decoders 162 and 165 respectively decode the audio and video data provided, via the PVR interface 140, from the storage medium 150 or from one of the TS decoder 133 and the MPEG-2 encoder 136. The audio processor 163 processes the decoded audio data into a signal for output via the speaker 164, while the video display processor 166 processes the decoded video data into a signal for output by the display module 167. At this time, the video display processor 166 may combine the processed video signal with OSD data generated by the OSD generator, to output text and a graphics-based image including a recording list in the form of a selectable menu, while scaling and positioning reproduced frames of a stored video signal accordingly. This scaling provides for corresponding thumbnails and video samples to be selectively displayed within a coinciding screen area and for multiple such coinciding screen areas to be simultaneously displayed on the same screen. Thus, using an OSD function, the display output of the output section 160 enables a user selection of a specific thumbnail or other screen area to initiate a display of the corresponding video sample. The video sample may be looped.

2A-2C illustrate exemplary screen images of a recording list displayed in a video apparatus according to respective embodiments of the present invention. A recording list, for example, files 1, 2, and 3, may include indications of any number of recording items, namely, one or more stored video streams or stored programs, where video streams may be identified by or arranged according to source or medium and where programs may be identified by or arranged according to individual program information. Recording item details include at least one of a recording source, a program title, a program genre, a viewer rating, and recording time information (including a recording date). In each case, a recording list (screen image) is displayed on a main screen of the video apparatus in response to a user command input via the user interface 110, whereupon the system controller 120 reads an index referencing recording item details and other corresponding recording item information (i.e., the thumbnails and video samples) that have been stored in the storage medium 150 for each recording item and displays the referenced information in a menu format reflecting the recording list. At the same time, one or more progress bars may be displayed. Each progress bar is displayed in association with a selectable recording item (file) and indicates, using an indicator moving along a cache bar, a current playback status (00:00:00/) of the corresponding video sample based on a total recording time (00:00:00). To selectively review a video sample, the indicator may be manipulated by, for example, a drag-and-release action, and the progress bar may be used for an execution of a time-shift function and other trick-play features (i.e., variable-speed playback including reverse playback and looping) for the video sample as well as for the entire video file. A progress bar, or more specifically, its cache bar, may be imparted with a display length varying in proportion to a recording time length of the corresponding recording item, using a reference value corresponding to a display length. On the other hand, the progress bar display length may correspond to the size of a video sample under preview.

According to a first embodiment of the present invention, there is at least one video display window (screen area) for displaying a thumbnail image and a video sample corresponding to each recording item. At the same time, there is at least one progress bar displayed in a screen area of the recording list in correspondence to each recording item.

According to a second embodiment of the present invention, there is at least one video display window for displaying a thumbnail image and a video sample corresponding to each recording item. At the same time, there is at least one common progress bar displayed in a screen area of the recording list in correspondence to a selected recording item. Here, user selection of a video sample corresponding to a recording item may be achieved by selecting a corresponding thumbnail.

According to a third embodiment of the present invention, there is at least one common video display window for displaying a thumbnail or preview image (video sample) corresponding to a selected recording item. At the same time, there is at least one progress bar displayed in a screen area of the recording list in correspondence to each recording item. Here, user selection of a video sample corresponding to a recording item may be achieved by activating a corresponding progress bar.

According to a fourth embodiment of the present invention, there is at least one common video display window for displaying a thumbnail or preview image (video sample) corresponding to a selected recording item. At the same time, there is at least one common progress bar displayed in a screen area of the recording list in correspondence to a selected recording item. Thus, the window of a displayed recording list is a common window for the specified video program (recording item) of the recording list and the progress bar of a displayed recording list is a common progress bar for the specified video program (recording item) of the recording list. In this case, the user selection of a video sample corresponding to a recording item is achieved by a user clicking on a screen area corresponding to a recording item feature (additional information) corresponding to the target video program of the displayed recording list.

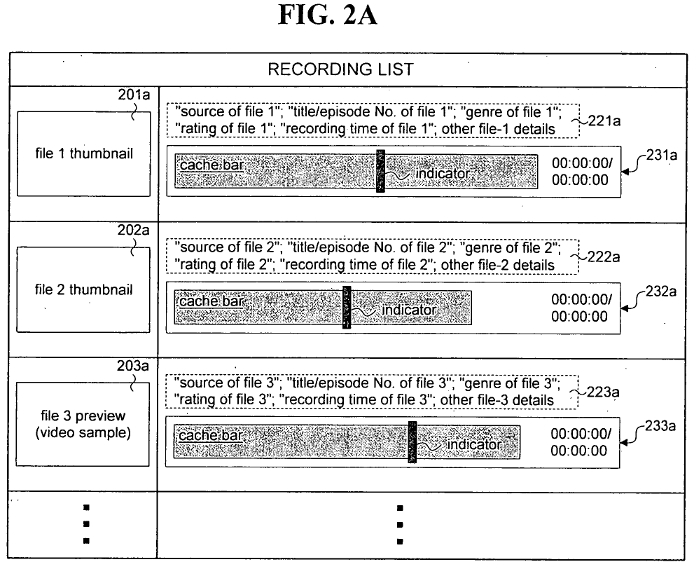

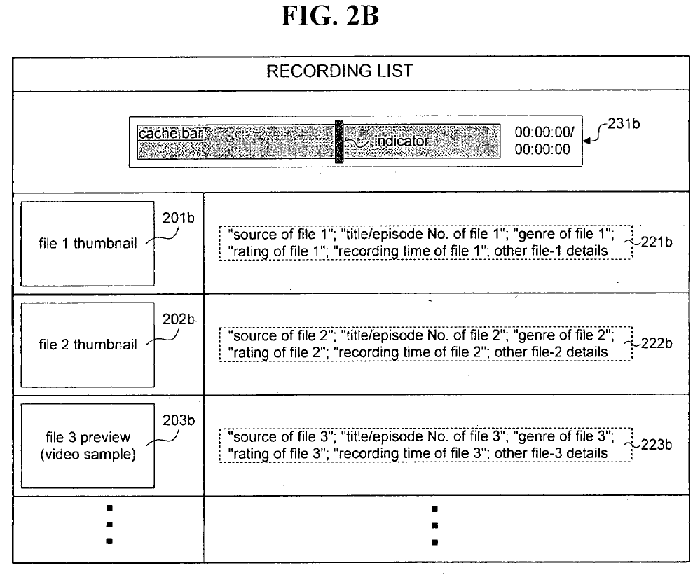

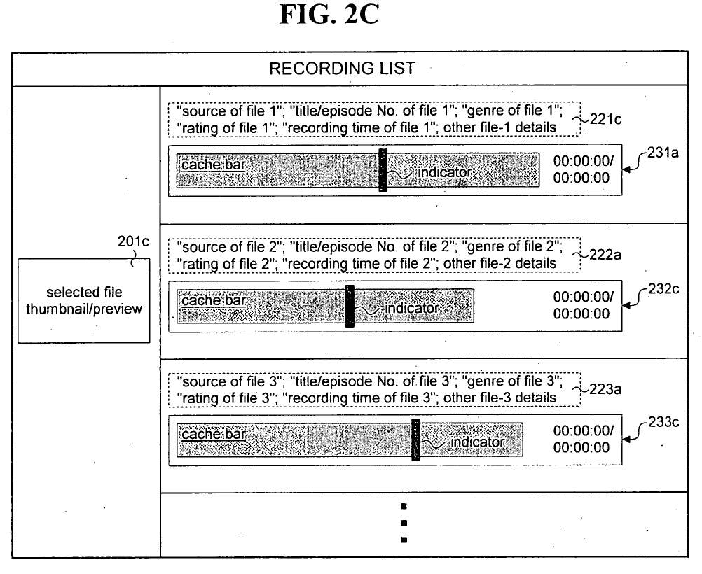

Referring to the screen image of FIG. 2A illustrating the first embodiment of the present invention, a recording list includes three files and is displayed as part of a menu where thumbnails 201a, 202a, and 203a are respectively displayed in association with corresponding recording item details 221a, 222a, and 223a. A progress bar is also displayed in association with each recording item. Initially, that is, in immediate response to a recording list display request from a user, a thumbnail image is displayed in association with each recording item. By selecting (e.g., “clicking” on) one of the thumbnails, a video sample corresponding to the selected thumbnail is displayed as a preview appearing in a screen area coinciding with the screen area initially occupied by the corresponding thumbnail, and may be looped according to its predetermined period, while the other thumbnails 201a and 202a and the recording item details 221a, 222a, and 223a remain displayed with their original appearance. In the event of preview playback, a corresponding one of progress bars 231a, 232a, and 233a indicates the current status of the corresponding video sample.

Referring to the screen image of FIG. 2B illustrating the second embodiment of the present invention, a recording list includes three files and is displayed as part of a menu where thumbnails 201b, 202b, and 203b are respectively displayed in association with corresponding recording item details 221b, 222b, and 223b. As in the case of the first embodiment, a thumbnail image is initially displayed in association with each recording item, and by selecting (e.g., “clicking” on) one of the thumbnails, a video sample corresponding to the selected thumbnail is displayed as a preview appearing in a screen area coinciding with the screen area initially occupied by the corresponding thumbnail, and may be looped according to its predetermined period, while the other thumbnails 201b and 202b and the recording item details 221b, 222b, and 223b remain displayed with their original appearance. In this embodiment, however, a common progress bar 231b is displayed in association with the recording list, that is, rather than individual progress bars being displayed in association with recording item. Thus, in the event of preview playback, the common progress bar 231b indicates the current status of the corresponding video sample. In this case, rather than a proportional display length, the common progress bar 231b may have a display length set according to the greatest recording time among the recording items of the displayed recording list.

Referring to the screen image of FIG. 2C illustrating the third embodiment of the present invention, a recording list includes three files and is displayed as part of a menu where a common thumbnail/preview image 201c is displayed together with recording item details 221c, 222c, and 223c corresponding to each recording item. Also, as in the case of the first embodiment, a progress bar is displayed in association with each recording item. In this embodiment, however, the screen area of the common thumbnail/preview image 201c is initially blank. By producing a first “click” on one of the recoding item screen areas, such as one of the recording item details 221c, 222c, and 223c, a thumbnail corresponding to the selected recording item is displayed in the screen area of the common thumbnail/preview image 201c. Thereafter, by producing a second “click” (or “double click” action) on one of the recoding item screen areas, namely, one of the recording item details 221c, 222c, and 223c, a video sample corresponding to the selected recording item is displayed in the screen area of the common thumbnail/preview image 201c and may be looped according to its predetermined period. Meanwhile, as in the case of the other embodiments, a corresponding one of progress bars 231c, 232c, and 233c indicates the current status of the corresponding video sample in the event of preview playback, and the progress bars and recording item details remain displayed with their original appearance regardless of recording item selection. As an alternative, rather the screen area of the common thumbnail/preview image 201c being initially blank, the initial display may include an image corresponding to a first or representative thumbnail (or icon) of the recording list or the thumbnail or video sample of the last-selected recording item.

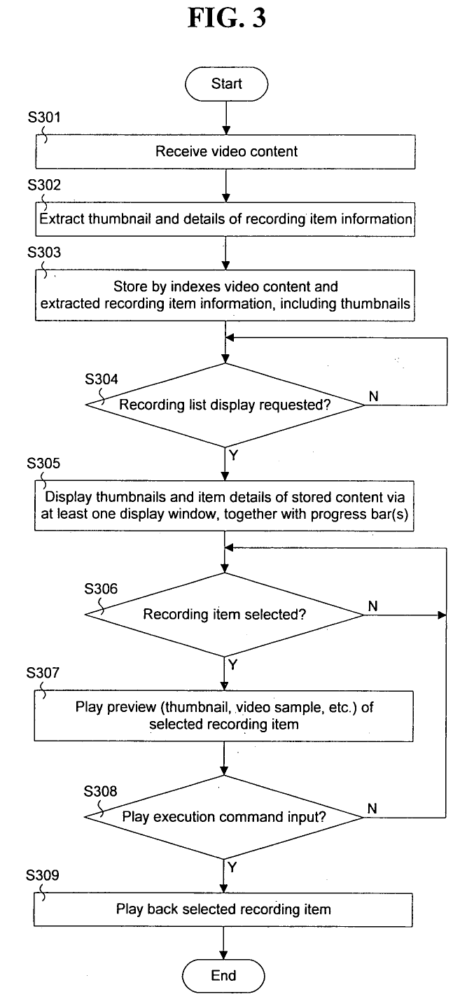

FIG. 3 illustrates a method of controlling a video apparatus according to the present invention. The video apparatus control method of the present invention includes the display of a recording list, such as that of FIGS. 2A-2C, facilitating user access to recorded content received and stored by the video apparatus. Here, the video apparatus may be a receiver such as a television receiver or set-top box provided with a video recorder including a video storage device (e.g., hard disk drive) such as that for a personal video recorder or digital video recorder.

Referring to FIG. 3, a video signal is received by the video apparatus (S301). The received video signal to be stored in the storage medium 150 may be a video stream including a plurality of programs as individual files, where the stored video signal is arranged according to program, or the received video signal may comprise a plurality of video streams as individual files, where the stored video signal is arranged according to source. In any case, the stored video content comprises a stream of transport packets, i.e., a transport stream containing audio and video data corresponding to a plurality of frames, and each file of stored content corresponds to an item of the recording list. The received video stream may be determined according to a user selection of a tuned channel carrying one or more digital broadcast programs or a user selection of an alternate input signal (source) such as that received via the analog tuner 134. In any event, recording item details are obtained for storage in the storage medium 150 in correspondence with each file of stored content, using, for example, the PSIP data extractor 121b or using an input signal supplied after storage via the user interface 110 according to one or more user commands.

Meanwhile, under control of the system controller 120, the thumbnail and video sampler 121a selects specific frames representative of the stored video content, whereby one selected frame is extracted to serve as a thumbnail image, and corresponding recording item details are also extracted or otherwise input (S302). Here, a plurality of consecutive frames may be extracted to serve as a video sample. Then, the received video content as well as the extracted frames and details of the recording item information are stored in the storage medium 150 according to an index corresponding to each item of a recording list to be displayed (S303). Thereafter, in response to a user command requesting display of a recording list, a screen image as shown in one of FIGS. 2A-2C is generated with reference to the stored indices and is displayed on a main screen of the video apparatus via the display module 167, using at least one screen area for displaying a thumbnail/preview image and a corresponding set of recording item details (S304, S305). At the same time, at least one progress bar is also displayed.

At this time, based on the recording item details (e.g., 221˜223), a user may be imparted with a mental approximation of the stored contents of a recording item. To gain an appreciation of the exact contents of a specific recording item, a user command is input via the user interface 110 to select the corresponding recording item for preview (S306). Here, the user may select a specific recording item by clicking on a screen area corresponding to a thumbnail image displayed in association with the at least one feature of the recording item details or by clicking on a screen area corresponding to the at least one feature of recording item details. In response to this user command selecting a specific recording item, the system controller 120 plays a preview of the selected recording item by displaying the corresponding video sample in a predetermined screen area, for example, within a coinciding screen area of the corresponding thumbnail image (S307). In other words, the displayed video sample occupies a screen area coinciding with a screen area previously occupied by the corresponding thumbnail image. By thus playing the preview, at least part of a stored video program is displayed in the corresponding screen area, or window, and the at least part of the stored program may consist of one frame (i.e., a thumbnail), a series of frames (i.e., a video sample), or the entire program as stored in the storage medium 150. In the event that a play execution command is input while a selected video sample is running, the system controller 120 may directly execute the corresponding playback operation (S308, S309). Other command executions may similarly be directly carried out on the selected recording item, including operations for entering an item of a playlist under creation and other file-access-dependent operations, e.g., editing or deletion.

The present invention is applicable to television receivers including projection television receivers and monitors, to video recorders such as a personal video recorder or digital video recorder, and to flat-panel display devices such as a PDP, LCD, or organic LED. The present invention is further applicable to both analog and digital televisions as well as satellite television receivers and set-top boxes including a monitor and to other video information receivers, specifically including mobile receivers. Moreover, the present invention is applicable to any broadcast system, including NTSC, PAL, and SECAM systems.

By adopting the present invention, the present invention enables the construction of a recording list from a received stream, thereby providing an enhanced search function for each of a plurality of recording items appearing in a displayed recording list and enables viewing of a preview of a corresponding video file. At the same time, a user can easily determine recording length due to a relative length of a progress bar, while obtaining detailed information for a corresponding video through a displayed set of recording item details, to facilitate the user's recognition, identification, and selection of a specific recording item (e.g., stored program). Accordingly, information on recording items can be accurately and efficiently confirmed via a main screen without playing back recording items one by one, thereby facilitating user access to recorded content, including access for viewing, editing, and deletion, by providing means for improved file recognition and thereby increasing accuracy of the user's identification of recording files, using additional information provided for confirming the contents of a recording item being accessed. Therefore, users who may be unfamiliar with the contents of one or more recording items of a recording list can easily select a specific recording item to be reproduced or entered into a playlist.

It will be apparent to those skilled in the art that various modifications can be made in the present invention without departing from the spirit or scope of the invention. Thus, it is intended that the present invention covers such modifications provided they come within the scope of the appended claims and their equivalents.

What is claimed is:

1. A method of controlling a receiver, the method comprising:
receiving at least one video program; and
constructing a recording list from the received at least one video program, the recording list including at least one window, at least one progress bar, and additional information indicative of at least one feature identifying a corresponding video program of the recording list, each window corresponding to one video program of the recording list and each progress bar corresponding to one video program of the recording list,
wherein at least part of a specified video program is displayed in a corresponding window of the constructed recording list in response to a user command for controlling a corresponding progress bar of the constructed recording list.

2. The method of claim 1, wherein the at least part of the specified video program is selectively displayed as one of a thumbnail image representative of the specified video program and a video sample representative of the specified video program.

3. The method of claim 1, further comprising:
outputting the recording list to a display module.

4. The method of claim 1, further comprising:
displaying the recording list in response to a recording list display request.

5. The method of claim 4, said recording list displaying comprising:
displaying the additional information in a correspondence to each video program of the recording list; and
displaying, in response to the user command, a progress status of the specified video program being displayed in the corresponding window, the progress status indicated by a current position of an indicator of a corresponding progress bar with respect to a display length of the corresponding progress bar.

6. The method of claim 1, wherein the received at least one video program includes an analog video signal and wherein the additional information corresponding to the analog video signal is set by a user.

7. The method of claim 1, wherein the received at least one video program includes a digital stream and wherein the additional information is extracted from the digital stream.

8. The method of claim 1, wherein the at least one window includes a specific window for each video program of the recording list and wherein the at least one progress bar includes a specific progress bar for each video program of the recording list.

9. The method of claim 1, wherein the at least one window includes a specific window for each video program of the recording list and wherein the at least one progress bar includes a common progress bar for the specified video program of the recording list.

10. The method of claim 1, wherein the at least one window includes a common window for the specified video program of the recording list and wherein the at least one progress bar includes a specific progress bar for each video program of the recording list.

11. The method of claim 1, wherein the at least one window includes a common window for the specified video program of the recording list and wherein the at least one progress bar includes a common progress bar for the specified video program of the recording list.

12. A method of controlling a receiver, the method comprising:
storing in a video storage device at least one stream of audio and video data corresponding to a plurality of frames, each stream including additional information indicative of at least one feature of a set of recording item details for identifying a recording item;
extracting recording item information included in each stream, the recording item information including the at least one recording item feature for each item of a recording list;
displaying, in response to a user command requesting display of the recording list, the stored at least one recording item feature and at least one window in association with the at least one recording item feature; and
displaying, in response to a user command selecting a specific recording item, at least part of the stream stored in correspondence to the selected recording item.

13. The method of claim 12, wherein the at least one stream is received by the receiver as a stream of audio and video data including a plurality of programs.

14. The method of claim 13, wherein the stored at least one stream is arranged according to program.

15. The method of claim 13, wherein the stored at least one stream is arranged according to source.

16. The method of claim 13, further comprising:
storing the extracted recording item information in correspondence to the recording list,
wherein the extracted recording item information further includes at least one of a thumbnail image corresponding to each stream and a video sample corresponding to each stream.

17. The method of claim 12, wherein the set of recording item details includes at least one feature specified by a user.

18. The method of claim 12, wherein the specific recording item is selected by a user clicking on a screen area corresponding to a window displayed by said at least one window displaying.

19. The method of claim 12, wherein the specific recording item is selected by a user clicking on a screen area corresponding to the at least one recording item feature.

20. The method of claim 12, wherein the displayed at least part of the stream occupies a screen area coinciding with the at least one window.

21. The method of claim 20, wherein the coinciding screen area corresponds to each recording item.

22. The method of claim 20, wherein the coinciding screen area is a common video display window for selectively displaying a thumbnail and video sample corresponding to the selected recording item.

23. The method of claim 22, wherein the displayed video sample has a length equal to a length of the selected recording item.

24. The method of claim 22, wherein the displayed video sample runs for a predetermined period less than a length of the selected recording item.

25. The method of claim 12, further comprising:
executing, in response to an execution command input while a selected video sample is running, any one of a playback operation corresponding to one of the selected recording item and the selected video sample, an editing operation corresponding to one of the selected recording item and the selected video sample, and a deletion operation corresponding to one of the selected recording item and the selected video sample.

26. The method of claim 12, further comprising:
displaying at least one progress bar in a screen area of the recording list in correspondence to each recording item.

27. The method of claim 26, wherein the displayed at least one progress bar is a common progress bar displayed in correspondence to the selected recording item.

28. The method of claim 26, wherein each progress bar has a display length proportional to a recording time length of the corresponding recording item.

29. The method of claim 26, wherein each progress bar has a display length proportional to a recording time length of the corresponding video sample.

30. The method of claim 12, wherein the set of recording item details includes at least one recording item feature selected from the group consisting of a recording source, a program title, a program genre, a viewer rating, and recording time information.

31. A receiver, comprising:
a signal receiving section for receiving at least one video program; and
a system controller for constructing a recording list from the received at least one video program, the recording list including at least one window, at least one progress bar, and additional information indicative of at least one feature identifying a corresponding video program of the recording list, each window corresponding to one video program of the recording list and each progress bar corresponding to one video program of the recording list; and
a user interface for generating a user command for controlling a corresponding progress bar of the constructed recording list,
wherein at least part of a specified video program is displayed in a corresponding window of the constructed recording list in response to the user command.

32. The receiver of claim 31, wherein the recording list is output to a display module.

33. The receiver of claim 31, further comprising:
a display module for displaying the recording list in response to a recording list display request.

34. A receiver, comprising:
a video storage device for storing at least one video program including additional information indicative of at least one feature of each stored video program;
a recording item information extractor for extracting recording item information from each stream, the recording item information including the at least one video program feature for each item of a recording list; and
a system controller for outputting the recording list in response to a user command requesting display of the recording list, the output recording list including at least one window in association with the stored at least one video program feature, and for controlling, in response to a user command selecting a specific recording item, a corresponding window to display at least part of the video program according to the selected recording item.
